(19) United States
(12) Patent Application Publication
(10) Pub. No.: US 2023/0367926 A1
(43) Pub. Date: Nov. 16, 2023

(54) SOLUTION SYSTEM AND SOLUTION METHOD

(71) Applicant: NEC Corporation, Minato-ku, Tokyo (JP)

(72) Inventor: Yuta ldeguchi, Tokyo (JP)

(73) Assignee: NEC Corporation, Minato-ku, Tokyo (JP)

(21) Appl. No.: 18/030,715

(22) PCT Filed: Oct. 21, 2020
(86) PCT No.: PCT/JP2020/039619

§ 371 Date: Apr. 6, 2023

(51) Int. Cl. G06F 30/20

(52) U.S. Cl. CPC G06F 30/20; G06F 2111/06

(57) ABSTRACT

The first energy change calculation means 71 calculates, when given an expression that represents energy in a combinatorial optimization problem and that includes an objective function and a constraint term, first energy change which is change of value of the constraint term when flipping any spin in each local solution of the combinatorial optimization problem. The second energy change calculation means 72 calculates second energy change which is change of a value of the objective function when flipping any spin in each local solution. The third energy change calculation means 73 calculates multiple types of third energy changes which are changes of the energy represented by the expression when flipping any spin in each local solution, based on the first energy change and the second energy change.

### TECHNICAL FIELD

The present invention relates to a solution system, a solution method, and a computer-readable recording medium in which a solution program is recorded, for finding an optimal solution to a combinatorial optimization problem.

### BACKGROUND ART

When finding an optimal solution to a combinatorial optimization problem, an expression representing the energy in the combinatorial optimization problem is created. This expression representing the energy can be converted to the form of the Ising model. This conversion method is known. The Ising model is a model in statistical mechanics that represents the behavior of a magnetic material by individual spins, and it is also applicable to solving combinatorial optimization problems. In the Ising model, the states of individual spins are represented by “1” or “−1”.

The Ising model is expressed as in Expression (1) below.

[Math. 1]

E=ΣᵢΣⱼJᵢⱼsᵢsⱼ+Σᵢhᵢsᵢ (1)

Both i and j in Expression (1) are variables representing a spin. In addition, sᵢ in Expression (1) is a variable representing the state of spin i, and sⱼ is a variable representing the state of spin j. Jᵢⱼ in Expression (1) is a constant corresponding to a combination of spin i and spin j. More specifically, Jᵢⱼ is a constant that represents interaction between spin i and spin j. For each combination of possible value of i and possible value of j, Jᵢⱼ is determined as a constant. Also, hᵢ in Expression (1) is a constant corresponding to spin i. For each possible value of i, hᵢ is determined as a constant.

Expression (1), which represents the Ising model, is applied to pseudo-quantum annealing, and an optimal solution to a combinatorial optimization problem is found by executing pseudo-quantum annealing. Pseudo-quantum annealing is also called simulated annealing.

In pseudo-quantum annealing (simulated annealing), a reciprocal of a temperature is referred to as an inverse temperature.

In pseudo-quantum annealing, the optimal solution is found among multiple local solutions. Each local solution corresponds to states of spins in which a constraint in the combinatorial optimization problem is satisfied.

PTL 1 describes a simulated annealing method in which the temperature is controlled to be lowered.

### CITATION LIST

### Patent Literature

PTL 1: Japanese Patent Application Laid-Open No. 2020-106917

### SUMMARY OF INVENTION

### Technical Problem

In pseudo-quantum annealing, the optimal solution to a combinatorial optimization problem may be found while increasing and decreasing the inverse temperature.

Since one local solution is not necessarily the optimal solution, it is necessary to flip one of the spins in the local solution to transition to another local solution.

When the inverse temperature is low, one of the spins can be flipped in the local solution. As the inverse temperature increases, it becomes more difficult to flip a spin in the local solution, and when the inverse temperature is higher than a certain inverse temperature, it becomes impossible to flip a spin in the local solution.

In general, when the optimal solution is found by increasing and decreasing the inverse temperature in pseudo-quantum annealing, parameters such as the range of inverse temperature and the degree to which the inverse temperature should be varied when it is varied are determined through multiple trials of pseudo-quantum annealing. Then, pseudo-quantum annealing is performed using the determined parameters. Therefore, it takes time to determine the parameters.

Another problem is that when pseudo-quantum annealing is performed, if there is no optimal solution in the vicinity of the local solution reached, it takes time to reach the optimal solution from that local solution.

It is therefore an object of the present invention to provide a solution system, a solution method, and a computer-readable recording medium in which a solution program is recorded that can reduce the time to find an optimal solution to a combinatorial optimization problem.

### Solution to Problem

A solution system according to the present invention includes: first energy change calculation means for calculating, when given an expression that represents energy in a combinatorial optimization problem and that includes an objective function and a constraint term, first energy change which is change of value of the constraint term when flipping any spin in each local solution of the combinatorial optimization problem; second energy change calculation means for calculating second energy change which is change of a value of the objective function when flipping any spin in each local solution; third energy change calculation means for calculating multiple types of third energy changes which are changes of the energy represented by the expression when flipping any spin in each local solution, based on the first energy change and the second energy change; inverse temperature calculation means for calculating an inverse temperature at which any of spins can be flipped in each local solution for each individual third energy change, and for calculating an inverse temperature at which the spins can be regarded as not being able to flip in each local solution; and annealing means for executing pseudo-quantum annealing using calculated multiple inverse temperatures.

A solution method according to the present invention is implemented by a computer, and comprises: calculating, when given an expression that represents energy in a combinatorial optimization problem and that includes an objective function and a constraint term, first energy change which is change of value of the constraint term when flipping any spin in each local solution of the combinatorial optimization problem; calculating second energy change which is change of a value of the objective function when flipping any spin in each local solution; calculating multiple types of third energy changes which are changes of the energy represented by the expression when flipping any spin in each local solution, based on the first energy change and the second energy change; calculating an inverse temperature at which any of spins can be flipped in each local solution for each individual third energy change, and calculating an inverse temperature at which the spins can be regarded as not being able to flip in each local solution; and executing pseudo-quantum annealing using calculated multiple inverse temperatures.

A computer-readable recording medium according to the present invention is a computer-readable recording medium in which a solution program is recorded, wherein the solution program causes a computer to execute: a first energy change calculation process of calculating, when given an expression that represents energy in a combinatorial optimization problem and that includes an objective function and a constraint term, first energy change which is change of value of the constraint term when flipping any spin in each local solution of the combinatorial optimization problem; a second energy change calculation process of calculating second energy change which is change of a value of the objective function when flipping any spin in each local solution; a third energy change calculation process of calculating multiple types of third energy changes which are changes of the energy represented by the expression when flipping any spin in each local solution, based on the first energy change and the second energy change; an inverse temperature calculation process of calculating an inverse temperature at which any of spins can be flipped in each local solution for each individual third energy change, and of calculating an inverse temperature at which the spins can be regarded as not being able to flip in each local solution; and an annealing means of executing pseudo-quantum annealing using calculated multiple inverse temperatures.

### Advantageous Effects of Invention

According to the present invention, the time to find an optimal solution to a combinatorial optimization problem can be reduced.

### BRIEF DESCRIPTION OF DRAWINGS

FIG. 1 It depict a block diagram showing an example configuration of a solution system of the example embodiment of the present invention.

FIG. 2 It depicts a schematic diagram showing an example of a local solution to the traveling salesman problem.

FIG. 3 It depicts a flowchart showing an example of the processing flow of the solution system of the example embodiment of the present invention.

FIG. 4 It depicts a flowchart showing an example of the processing flow of step S7 executed by the pseudo-quantum annealing execution unit.

FIG. 5 It depicts a schematic block diagram showing an example of computer configuration of the solution system of the example embodiment of the present invention.

FIG. 6 It depicts a block diagram showing an overview of the solution system of the present invention.

### DESCRIPTION OF EMBODIMENTS

An example embodiment of the present invention is described below with reference to the drawings.

The solution system in the present example embodiment obtains multiple inverse temperatures and executes pseudo-quantum annealing (simulated annealing) using the multiple inverse temperatures when finding an optimal solution to a combinatorial optimization problem.

In pseudo-quantum annealing, the solution system of the present example embodiment first determines that all spins are unselected, and selects one spin at a time from the unselected spins. Then, the solution system determines whether or not to flip the selected spin, and when the solution system determines to flip the spin, the solution system flips the spin (the selected spin). Flipping a spin means reversing the state of the spin. Specifically, flipping a spin means reversing the state of the spin from “1” to “−1” or from “−1” to “1”. After selecting all spins and making the above determinations for all spins, the solution system changes the inverse temperature to the inverse temperature that is higher than the current inverse temperature and closest to the current inverse temperature, when the solution system has determined to flip at least one spin. When the solution system determines that no flipping has been performed for all spins, the solution system changes the inverse temperature to the inverse temperature that is lower than the current inverse temperature and closest to the current inverse temperature. After that, the solution system again determines that all spins are unselected, and repeats the same process. By repeating this process, the solution system finds the optimal solution to the combinatorial optimization problem.

Here, when the solution system determines whether or not to flip the selected spin, the solution system calculates the energy change of the combinatorial optimization problem in the case of flipping the spin. This energy change is denoted as ΔE. Also, let T be the inverse temperature at that point in time. The solution system finds a probability p=exp(−ΔE*T) and determines whether or not to flip the selected spin according to the probability p.

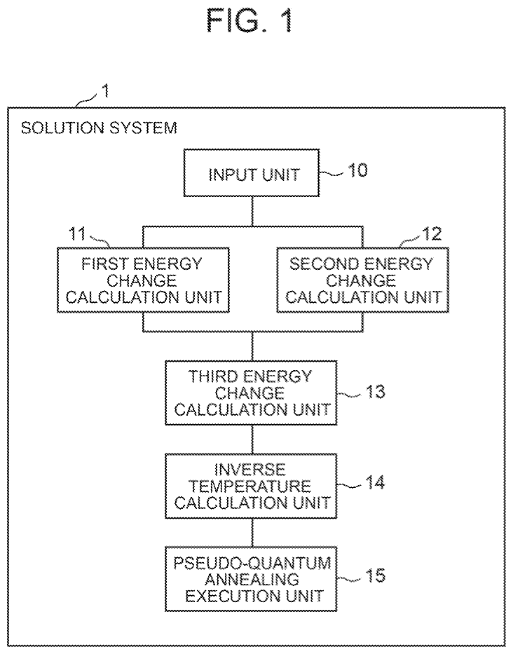

FIG. 1 is a block diagram showing an example configuration of the solution system of the example embodiment of the present invention. The solution system 1 of the present example embodiment includes an input unit 10, a first energy change calculation unit 11, a second energy change calculation unit 12, a third energy change calculation unit 13, an inverse temperature calculation unit 14, and a pseudo-quantum annealing execution unit 15.

An expression representing the energy in a combinatorial optimization problem is input to input unit 10. This expression is an expression that includes an objective function and a constraint term. An example of the expression input to input unit 10 is shown in Expression (2). E, shown on the left side of Expression (2), represents the energy in the combinatorial optimization problem. Expression (2) also shows an example where the combinatorial optimization problem is a traveling salesman problem. Here, the case where the combinatorial optimization problem is a traveling salesman problem will be explained as an example.

$$[ Math . 2 ]$$

$$E = {\sum }_{i} {\sum }_{j} {d}_{ij} ( {s}_{i} + 1 ) ( {s}_{j} + 1 ) / 4 + A {\sum }_{k} {( ( {\sum }_{j = {f}_{k} ( 0 )}^{{f}_{k} ( {n}_{k} )} ( {s}_{j} + 1 ) / 2 ) - 1 )}^{2} \qquad ( 2 )$$

The objective function is a function that represents the matter whose value is to be minimized in a combinatorial optimization problem. In Expression (2), the first term on the right side corresponds to the objective function.

A constraint term is a term that represents a constraint in a combinatorial optimization problem. Constraints in a combinatorial optimization problem are not limited to one, but can be multiple. In Expression (2), the second term on the right side corresponds to the constraint term.

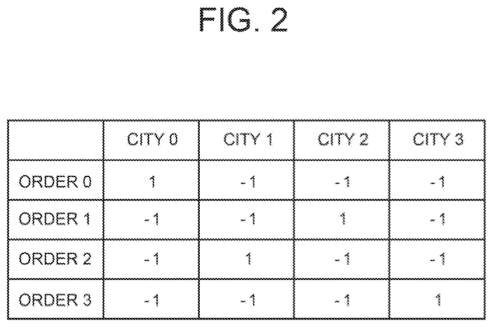

FIG. 2 is a schematic diagram showing an example of a local solution to the traveling salesman problem. FIG. 2 illustrates the case where the salesman visits four cities. In FIG. 2, the four cities are shown on the horizontal axis and the order in which the salesman visits the cities is shown on the vertical axis. In this example, the order is assumed to start from 0. In this example, it is assumed that there are 16 spins and that each individual spin is assigned an identification number (integer) from 0 to 15. That a state of spin is “1” means that the salesman exists, while that a state of spin is “−1” means that the salesman does not exist.

In the traveling salesman problem, the salesman is constrained to visit a city only once. Thus, for example, when the column for city 0 (see FIG. 2) is focused on, there is a constraint that only one spin is “1” in that column. The same is true for the three columns of the other cities. Thus, in the example shown in FIG. 2, there are four constraints on the columns.

Also, in the traveling salesman problem, there is the constraint that a salesman cannot be in more than one city at the same time. Thus, for example, when the row of order 0 (see FIG. 2) is focused on, there is a constraint that only one spin is “1” in that row. The same is true for the three rows of the other orders. Thus, in the example shown in FIG. 2, there are four constraints on the rows.

Accordingly, in the example shown in FIG. 2, there are 8 constraints. Since the states of 16 spins shown in FIG. 2 satisfy all 8 of these constraints, it can be said that these states correspond to a local solution.

Both i and j in Expression (2) are variables representing the identification number of a spin. In addition, sᵢ in Expression (2) is a variable representing the state of spin i and sⱼ is a variable representing the state of spin j. dᵢⱼ is the distance between the city corresponding to spin i (the city corresponding to the column in which spin i is located in FIG. 2) and the city corresponding to spin j (the city corresponding to the column in which spin j is located in FIG. 2), and dᵢⱼ for the combination of i and j is predefined.

In addition, k in Expression (2) is a variable representing the constraint. As mentioned above, there are 8 constraints in the example shown in FIG. 2, so k is an integer between 0 and 7.

The fₖ(0) in Expression (2) is the identification number of the first (0th) spin in the spins corresponding to constraint k. The fₖ (nₖ) is the identification number of the last (nₖ-th) spin in the spins corresponding to constraint k. In this example, the number of spins corresponding to any of the eight constraints is 4, so nₖ=3 for any constraint. However, depending on the type of combinatorial optimization problem, the number of spins corresponding to a constraint may be different depending on the constraint.

The value of the constraint term is 0 when all constraints of the combinatorial optimization problem are satisfied, and non-zero when any of the constraints is not satisfied.

The value of the constant A (see Expression (2)) included in the constraint term is set to a relatively large value because the solution is not optimal unless all constraints are satisfied.

The objective function and the constraint term can each be converted into the same form as the Ising model (see Expression (1)). Expression (3) below shows the expression in which the objective function (the first term on the right side) and the constraint term (the second term on the right side) in Expression (2) are converted into the same form as the Ising model, respectively.

[Math. 3]

E=ΣᵢΣⱼJ′ᵢⱼsᵢsⱼ+Σᵢh′ᵢsᵢ+ΣᵢΣⱼĴᵢⱼsᵢsⱼ+Σᵢ\vec{h}ᵢsᵢ (3)

The first and the second terms on the right side in Expression (3) are the result of converting the objective function in Expression (2) to the form of the Ising model. The third and the fourth terms on the right side in Expression (3) are the result of converting the constraint term in Expression (2) to the form of the Ising model.

Furthermore, the expression shown in Expression (3) can be converted to an expression in the form of the Ising model shown in Expression (1). Thus, the expression representing energy illustrated in Expression (2) can be converted to an expression in the form of the Ising model shown in Expression (1).

The expression including the objective function and the constraint term (the expression representing energy), as shown in Expression (2), is created in advance by the user of the solution system 1 and input into the input unit 10.

The input unit 10 may be an input device such as, for example, a keyboard. Alternatively, the input unit 10 may be realized by a data reading device that reads the expression (the expression including the objective function and constraint term illustrated in Expression (2)) recorded on a data recording medium such as an optical disk, for example.

The energy change in flipping any of the spins from the state of each spin where all constraints are satisfied (in other words, the local solution) is large.

Since the determination to flip the selected spin is made probabilistically, it is possible to flip one of the spins in the local solution even if the inverse temperature is somewhat high.

Here, the energy change when flipping any spin in each local solution of the combinatorial optimization problem can be said to be similar to the change of the value of the constraint term when flipping any spin in each local solution.

On the other hand, the energy is affected by the objective function as well as the constraint term (see Expression (2)). Therefore, when obtaining the energy change when flipping any of the spins in each local solution, the change of the value of the objective function when flipping any of the spins in each local solution is also obtained. However, the change of the value of the objective function may be obtained approximately.

Hereafter, the change of the value of the constraint term when flipping any of the spins in each local solution is denoted as the first energy change.

The change of the value of the objective function when flipping any of the spins in each local solution is noted as the second energy change.

Also, the change of energy shown by the expression that represents the energy in the combinatorial optimization problem and that includes the objective function and the constraint term (e.g., the expression illustrated in Expression (2)) when flipping any of the spins in each local solution is denoted as the third energy change. The third energy change corresponds to ΔE in p=exp(−ΔE*T) described above.

The first energy change calculation unit 11 calculates the first energy change. Specifically, the first energy change calculation unit 11 calculates the coefficient of each variable (e.g., so to sis) representing the state of each spin by expanding the constraint term (in the example shown in Expression (2), the second term on the right side). The coefficient of each variable representing the state of each spin are the first energy change.

The types of the above coefficients obtained by expanding the constraint are the types of values of the first energy changes. For example, when the constraint term of Expression (2), which represents the energy in the traveling salesman problem illustrated in FIG. 2, is expanded, the coefficient of each variable that represents the state of each spin is 2 A. Therefore, in this case, there is only one value of the first energy change, “2 A”.

How many different (in other words, how many) first energy changes are obtained depends on the constraint term included in the expression representing the energy in the combinatorial optimization problem.

In the following explanation, for simplicity, the case where two first energy changes are calculated is used. One of the two first energy changes is denoted as ΔE_{c1} and the other as ΔE_{c2}.

The second energy change calculation unit 12 calculates the second energy change. Here, when the objective function is converted to the form of the Ising model, the statistical value such as the mean value or the variance of the constants representing interaction between spins in the converted expression (J′ᵢⱼ in the first term on the right side of Expression (3). Hereafter, simply denoted as J′ᵢⱼ.) can be said to be approximate values of the second energy change. In addition, when the objective function is converted to the form of the Ising model, the statistical value such as the mean value or the variance of respective constants corresponding to spins in the converted expression (h′ᵢ in the second term on the right side of Expression (3). Hereafter, simply denoted as h′ᵢ.) can also be said to be approximate values of the second energy change.

The statistics of J′ᵢⱼ determined by the spins corresponding to any constraint and the statistics of h′ᵢ determined by the spins corresponding to any constraint can also be used as an approximation of the second energy change.

Here, for simplicity of explanation, the second energy change calculation unit 12 calculates, as the second energy changes, the mean value of J′ᵢⱼ (hereinafter referred to as ΔEₒ₁), the variance of J′ᵢⱼ (hereinafter referred to as ΔEₒ₂), the mean value of h′ᵢ (hereinafter referred to as ΔEₒ₃), and the variance of h′ᵢ (hereinafter referred to as ΔEₒ₄). However, the second energy change calculation unit 12 may calculate only some of ΔEₒ₁, ΔEₒ₂, ΔEₒ₃, and ΔEₒ₄, or at least one of these.

The second energy change calculation unit 12 converts the objective function in the expression (e.g., Expression (2)) input via input unit 10 to the form of the Ising model. That is, the second energy change calculation unit 12 converts the given objective function to the form of the first and second terms on the right side of Expression (3). Then, the second energy change calculation unit 12 calculates the mean value ΔEₒ₁ of J′ᵢⱼ, the variance ΔEₒ₂ of J′ᵢⱼ, the mean value ΔEₒ₃ of h′ᵢ, and the variance ΔEₒ₄ of h′ᵢ based on the converted expression.

The third energy change calculation unit 13 calculates multiple types of (in other words, multiple) third energy changes based on the first energy changes calculated by the first energy change calculation unit 11 and the second energy changes calculated by the second energy change calculation unit 12. Here, it is assumed that the calculated first energy changes are ΔE_{c1} and ΔE_{c2}, and the calculated second energy changes are ΔEₒ₁, ΔEₒ₂, ΔEₒ₃ and ΔEₒ₄.

First, the third energy change calculation unit 13 determines the first energy change as it is, as the third energy change. This is because, as mentioned above, the energy change when flipping any spin in each local solution can be said to be similar to the change of the value of the constraint term when flipping any spin in each local solution. In this example, the third energy change calculation unit 13 determines ΔE_{c1} and ΔE_{c2} as the third energy change, respectively.

Furthermore, the third energy change calculation unit 13 selects one first energy change and one second energy change, and determines the sum of the first energy change and the second energy change, and the subtraction of the second energy change from the first energy change, respectively, as the third energy changes. For example, it is assumed that the third energy change calculation unit 13 selects the first energy change ΔE_{c1} and the second energy change ΔEₒ₁. In this case, the third energy change calculation unit 13 calculates ΔE_{c1}+ΔEₒ₁ and ΔE_{c1}−ΔEₒ₁, respectively, and determines the calculated results as the third energy changes, respectively. The third energy change calculation unit 13 calculates the third energy changes for each pair of one first energy change and one second energy change that can be selected, in the same way.

As a result, in this example, the third energy change calculation unit 13 obtains the multiple third energy changes shown below.
ΔE_{c1}, ΔE_{c1}+ΔEₒ₁, ΔE_{c1}−ΔEₒ₁, ΔE_{c1}+ΔEₒ₂, ΔE_{c1}−ΔEₒ₂, ΔE_{c1}+ΔEₒ₃, ΔE_{c1}−ΔEₒ₃, ΔE_{c1}+ΔEₒ₄, ΔE_{c1}−ΔEₒ₄, ΔE_{c2}, ΔE_{c2}+ΔEₒ₁, ΔE_{c2}−ΔEₒ₁, ΔE_{c2}+ΔEₒ₂, ΔE_{c2}−ΔEₒ₂, ΔE_{c2}+ΔEₒ₃, ΔE_{c2}−ΔEₒ₃, ΔE_{c2}+ΔEₒ₄, ΔE_{c2}−ΔEₒ₄

These third energy changes are the changes of energy that the input expression represents when flipping any spin in each local solution.

The inverse temperature calculation unit 14 calculates the inverse temperature for each individual third energy change calculated by the third energy change calculation unit 13. Thus, the inverse temperature calculation unit 14 calculates multiple inverse temperatures.

As already mentioned, in pseudo-quantum annealing, solution system 1 first determines that all spins are unselected, and selects one spin at a time from the unselected spins. Then, the solution system 1 determines whether or not to flip the selected spin, and when the solution system 1 determines to flip the spin, the solution system 1 flips the spin (the selected spin). After selecting all spins and making the above determinations for all spins, the solution system 1 changes the inverse temperature to the inverse temperature that is higher than the current inverse temperature and closest to the current inverse temperature, when the solution system 1 has determined to flip at least one spin. When the solution system 1 determines that no flipping has been performed for all spins, the solution system 1 changes the inverse temperature to the inverse temperature that is lower than the current inverse temperature and closest to the current inverse temperature. After that, the solution system 1 again determines that all spins are unselected, and repeats the same process. Here, when all spins are selected and the above determination is made for all spins, preferably only one spin has been flipped.

Therefore, the inverse temperature calculation unit 14 calculates the inverse temperature T by setting the probability p in the aforementioned probability p=exp(−ΔE*T) as “1/the number of spins” and ΔE as the individual third energy change. Hereafter, the number of spins is denoted by M. Also, any third energy change among the multiple calculated third energy changes is denoted by ΔE′. In the aforementioned probability p=exp(−ΔE*T), when the probability p is “1/M” and ΔE is the third energy change ΔE′, it is expressed as in the following Expression (4). T is the inverse temperature.

1/M=exp(−ΔE′*T) (4)

From Expression (4), the inverse temperature T is expressed by the following Expression (5).

T=ln(M)/ΔE′ (5)

Therefore, the inverse temperature calculation unit 14 calculates multiple inverse temperatures T by substituting each individual third energy change calculated by the third energy change calculation unit 13 into ΔE′ in Expression (5). In other words, the inverse temperature calculation unit 14 calculates the inverse temperature T for each individual third energy change calculated by the third energy change calculation unit 13.

The multiple inverse temperatures thus obtained can be said to be relatively high inverse temperatures at which any of the spins can be flipped in each local solution.

The inverse temperature calculation unit 14 also calculates the inverse temperature at which the spins can be regarded as not being able to flip in each local solution. In this case, the aforementioned probability p may be determined to be, for example, 0.01 times of (1/M). In addition, the minimum value (denoted as ΔminE′) among multiple third energy changes is used as the third energy change when calculating the inverse temperature. In other words, the inverse temperature calculation unit 14 calculates the inverse temperature at which the spins can be regarded as not being able to flip in each local solution, for example, by the following Expression (6).

T=ln(M/0.01)/Δmin E′ (6)

The multiple inverse temperatures calculated as the relatively high inverse temperatures at which any of the spins can be flipped in each local solution, and the inverse temperature at which the spins can be regarded as not being able to flip in each local solution (e.g., the inverse temperature calculated by Expression (6)), are discrete values.

The inverse temperature at which the spins can be regarded as not being able to flip in each local solution is the highest inverse temperature among the inverse temperatures calculated by the inverse temperature calculation unit 14.

The pseudo-quantum annealing execution unit 15 converts the input expression representing energy (e.g., the expression illustrated in Expression (2)) to an expression in the form of the Ising model shown in Expression (1). Then, the pseudo-quantum annealing execution unit 15 executes pseudo-quantum annealing using the expression in the form of the Ising model and the multiple inverse temperatures calculated by the inverse temperature calculation unit 14 to find the optimal solution to the combinatorial optimization problem. The lowest inverse temperature among the calculated multiple inverse temperatures is used as the initial value of the inverse temperature in the pseudo-quantum annealing.

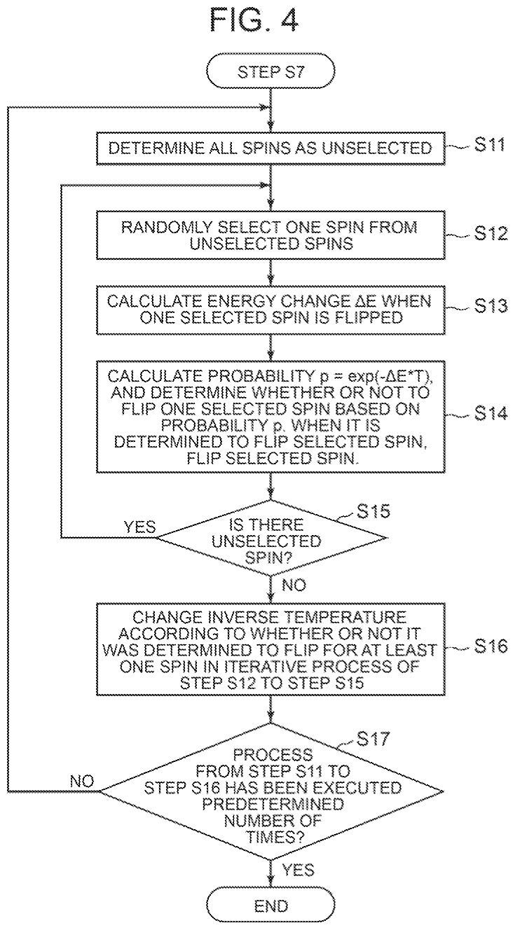

The detailed operation of the pseudo-quantum annealing execution unit 15 is described with reference to the flowchart in FIG. 4 below.

The first energy change calculation unit 11, the second energy change calculation unit 12, the third energy change calculation unit 13, the inverse temperature calculation unit 14, and the pseudo-quantum annealing execution unit 15 are realized, for example, by a CPU (Central Processing Unit) of a computer that operates according to a solution program. In this case, the CPU may read the solution program from a program recording medium such as a program storage device of the computer, and operates as the first energy change calculation unit 11, the second energy change calculation unit 12, the third energy change calculation unit 13, the inverse temperature calculation unit 14, and the pseudo-quantum annealing execution unit 15.

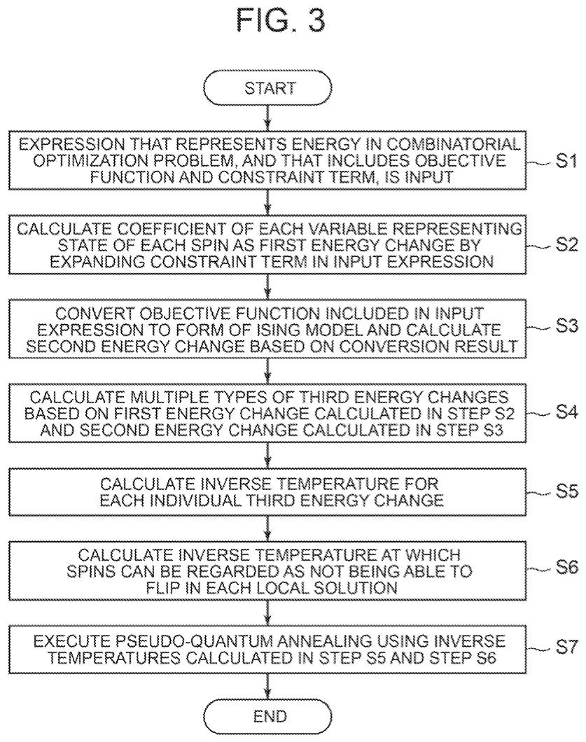

Next, the processing flow is described. FIG. 3 is a flowchart showing an example of the processing flow of the solution system of the present example embodiment. Matters that have already been explained will be omitted as appropriate.

First, an expression that represents energy in a combinatorial optimization problem and that includes an objective function and a constraint term, is input via input unit 10 (step S1). For example, the expression illustrated in Expression (2) is input in step S1.

The expression input in step S1 is created in advance by the user of the solution system 1.

When the expression representing the energy in the combinatorial optimization problem is input in step S1, the first energy change calculation unit 11 calculates the coefficient of each variable representing the state of each spin as the first energy change by expanding the constraint term in the input expression (step S2).

The second energy change calculation unit 12 converts the objective function included in the expression input in step S1 to the form of the Ising model and calculates the second energy change based on the conversion result (step S3).

For example, the second energy change calculation unit 12 converts the objective function as the first and the second terms on the right side of Expression (3) and calculates the mean value of J′ᵢⱼ, the variance of J′ᵢⱼ, the mean value of h′ᵢ, and the variance of h′ᵢ as the second energy change. As already explained, the second energy change calculation unit 12 may calculate only some of these, or at least one of these.

Next, the third energy change calculation unit 13 calculates multiple types of third energy changes based on the first energy change calculated in step S2 and the second energy change calculated in step S3 (step S4). The operation in which the third energy change calculation unit 13 calculates the multiple types of third energy changes has already been described, so the explanation is omitted here.

Next, the inverse temperature calculation unit 14 calculates the inverse temperature for each individual third energy change (step S5). The inverse temperature calculation unit 14 can calculate multiple inverse temperatures T by substituting each individual third energy change into ΔE′ in the aforementioned Expression (5).

The multiple inverse temperatures calculated in step S5 can be said to be relatively high inverse temperatures at which any of the spins can be flipped in each local solution.

The inverse temperature calculation unit 14 also calculates the inverse temperature at which the spins can be regarded as not being able to flip in each local solution (step S6). The inverse temperature calculation unit 14 can, for example, calculate this inverse temperature by calculating the aforementioned Expression (6).

The inverse temperature obtained in step S6 is higher than each inverse temperature obtained in step S5.

Next, the pseudo-quantum annealing execution unit 15 executes pseudo-quantum annealing using the inverse temperatures calculated in step S5 and step S6 (step S7). In step S7, the optimal solution to the combinatorial optimization problem is found.

FIG. 4 is a flowchart showing an example of the processing flow of step S7 executed by the pseudo-quantum annealing execution unit 15. Although it is not shown in FIG. 4, the pseudo-quantum annealing execution unit 15 converts the expression input in step S1 (see FIG. 3) to the form of the Ising model shown in Expression (1) when executing pseudo-quantum annealing. The pseudo-quantum annealing execution unit 15 also sets the lowest of the multiple inverse temperatures calculated in step S5 as the initial value of the inverse temperature. The pseudo-quantum annealing execution unit 15 also sets the state of each spin to an arbitrary state. Then, the process shown in FIG. 4 is executed.

First, the pseudo-quantum annealing execution unit 15 determines all spins as unselected (step S11). Specifically, the pseudo-quantum annealing execution unit 15 determines all spins as spins that have not yet been selected in step S12, which is described next.

After step S11, the pseudo-quantum annealing execution unit 15 randomly selects one spin from the unselected spins (step S12). The pseudo-quantum annealing execution unit 15 defines the spin which is selected as the selected spin.

Next, the pseudo-quantum annealing execution unit 15 calculates the energy change ΔE when one selected spin is flipped, based on an expression representing the energy (an expression in the form of the Ising model) (step S13).

Next, the pseudo-quantum annealing execution unit 15 calculates the probability p=exp(−ΔE*T), where T is the inverse temperature at the present time. Then, the pseudo-quantum annealing execution unit 15 determines whether or not to flip the one selected spin based on the probability p (step S14). When it is determined to flip the one selected spin, the pseudo-quantum annealing execution unit 15 also performs the process of flipping the selected spin in step S14. However, when it is determined not to flip the one selected spin, the pseudo-quantum annealing execution unit 15 does not flip the selected spin.

Next, the pseudo-quantum annealing execution unit 15 determines whether there is an unselected spin (step S15). When there is an unselected spin (step S15 Yes), the pseudo-quantum annealing execution unit 15 repeats the process from step S12 onward.

When there is no unselected spin (No in step S15), the process moves to step S16. In step S16, the pseudo-quantum annealing execution unit 15 changes the inverse temperature according to whether or not it was determined to flip for at least one spin in the iterative process of step S12 to step S15.

Specifically, when the determination was made to flip for at least one spin, the pseudo-quantum annealing execution unit 15 changes the inverse temperature to the inverse temperature that is higher than the current inverse temperature and closest to the current inverse temperature.

When the determination was made not to flip all spins, the pseudo-quantum annealing execution unit 15 changes the inverse temperature to the inverse temperature that is lower than the current inverse temperature and closest to the current inverse temperature.

Note that spins that are determined to be flipped in step S14 are flipped in step S14.

The changed inverse temperature in step S16 is one of the inverse temperatures calculated in step S5 and step S6.

After step S16, the pseudo-quantum annealing execution unit 15 determines whether the process from step S11 to step S16 has been executed a predetermined number of times (step S17).

When the number of times the process from step S11 to step S16 has been executed does not reached the predetermined number (No in step S17), the pseudo-quantum annealing execution unit 15 repeats the process from step S11 onward. In step S17, all spins are already selected, but in step S11, the pseudo-quantum annealing execution unit 15 again determines all spins as unselected.

When the number of times the process from step S11 to step S16 has been executed reaches the predetermined number (Yes in step S17), the pseudo-quantum annealing execution unit 15 determines the states of spins at that point as the optimal solution and terminates the process.

In the process of executing the process from step S11 to step S16 shown in FIG. 4 for the predetermined number of times, the state of each spin transitions from the initial state to the local solution. Here, the inverse temperatures calculated in step S5 and step S6 (see FIG. 3) are used as the inverse temperatures. Each inverse temperature calculated in step S5 is a relatively high inverse temperature at which any of the spins can be flipped in each local solution. Therefore, even if a transition is made to a local solution, any of the spins can be flipped from that state, resulting in a transition to another local solution. The inverse temperature calculated in step S6 is the inverse temperature at which the spins can be regarded as not being able to flip in the local solution. Therefore, when a transition is made to a local solution and the inverse temperature becomes the inverse temperature calculated in step S6, the states of spins converge to that local solution, and that local solution can be said to be the optimal solution. The process shown in FIG. 4 uses relatively high inverse temperatures at which any of the spins can be flipped in each local solution, so even if there is no optimal solution in the vicinity of a local solution, any of the spins can be flipped in the local solution. Therefore, since it is easier to transition to other local solutions, the optimal solution can be reached quickly even if the local solution is far from the optimal solution.

According to the present example embodiment, the third energy change calculation unit 13 calculates multiple types of energy changes (third energy changes) represented by the input expression (e.g., Expression (2)) when flipping any of the spins in each local solution. The inverse temperature calculation unit 14 then calculates, for each of the third energy changes, a relatively high inverse temperature at which any of the spins can be flipped in each local solution. The inverse temperature calculation unit 14 also calculates the inverse temperature at which the spins can be regarded as not being able to flip in each local solution. Then, the pseudo-quantum annealing execution unit 15 executes pseudo-quantum annealing (see FIG. 4) using those inverse temperatures, with increasing and decreasing the inverse temperatures.

Therefore, in the present example embodiment, there is no need to determine parameters such as the range of inverse temperature and the degree to which the inverse temperature should be varied when they are varied by performing multiple trials of pseudo-quantum annealing. In addition, as mentioned above, the process shown in FIG. 4 uses relatively high inverse temperatures at which any of the spins can be flipped in each local solution, so even if there is no optimal solution in the vicinity of a local solution, any of the spins can be flipped in the local solution. Therefore, since it is easier to transition to other local solutions, the optimal solution can be reached quickly even if the local solution is far from the optimal solution. Thus, according to the present example embodiment, the time to find an optimal solution to a combinatorial optimization problem can be reduced.

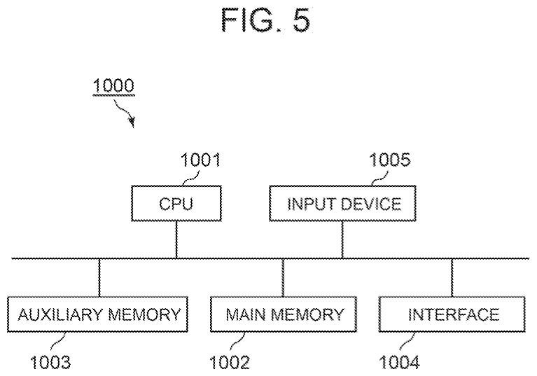

FIG. 5 is a schematic block diagram showing an example of computer configuration of the solution system of the example embodiment of the present invention. The computer 1000 includes a CPU 1001, a main memory 1002, an auxiliary memory 1003, an interface 1004, and an input device 1005.

The solution system 1 of the example embodiment of the present invention is realized by a computer 1000. The operation of the solution system 1 is stored in the auxiliary memory 1003 in the form of a solution program. The CPU 1001 reads the solution program from the auxiliary memory 1003, expands the solution program in the main memory 1002, and executes the process described in the above example embodiment according to the solution program.

The auxiliary memory 1003 is an example of a non-transitory tangible medium. Other examples of non-transitory tangible media include magnetic disks connected via interface 1004, magneto-optical disks, CD-ROM (Compact Disk Read Only Memory), DVD-ROM (Digital Versatile Disk Read Only Memory), a semiconductor memory, etc. When the program is delivered to the computer 1000 through a communication line, the computer 1000 may expand the program in the main memory 1002 and execute the process described in the above example embodiment according to the program.

Some or all of the components may be realized by general-purpose or dedicated circuitry, processor, or a combination of these. These may comprise a single chip or multiple chips connected via a bus. Some or all of the components may be realized by a combination of the above-mentioned circuitry, etc. and a program.

When some or all of components are realized by multiple information processing devices, circuits, etc., the multiple information processing devices, circuits, etc. may be centrally located or distributed. For example, the information processing devices and circuits may be realized as a client-and-server system, a cloud computing system, etc., each of which is connected via a communication network.

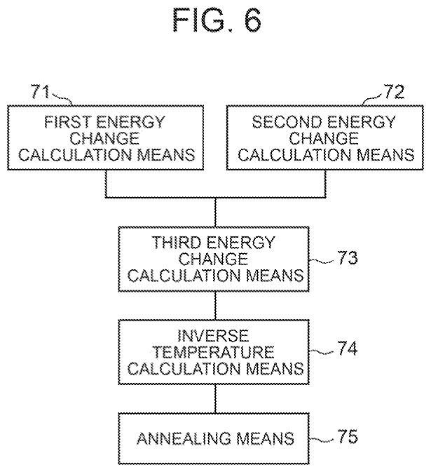

Next, an overview of the present invention is described. FIG. 6 is a block diagram showing an overview of the solution system of the present invention. The solution system of the present invention includes first energy change calculation means 71, second energy change calculation means 72, third energy change calculation means 73, inverse temperature calculation means 74, and annealing means 75.

The first energy change calculation means 71 (e.g., the first energy change calculation unit 11) calculates, when given an expression that represents energy in a combinatorial optimization problem and that includes an objective function and a constraint term, first energy change which is change of value of the constraint term when flipping any spin in each local solution of the combinatorial optimization problem.

The second energy change calculation means 72 (e.g., the second energy change calculation unit 12) calculates second energy change which is change of a value of the objective function when flipping any spin in each local solution.

The third energy change calculation means 73 (e.g., the third energy change calculation unit 13) calculates multiple types of third energy changes which are changes of the energy represented by the expression when flipping any spin in each local solution, based on the first energy change and the second energy change.

The inverse temperature calculation means 74 (e.g., the inverse temperature calculation unit 14) calculates an inverse temperature at which any of spins can be flipped in each local solution for each individual third energy change, and calculates an inverse temperature at which the spins can be regarded as not being able to flip in each local solution.

The annealing means 75 (e.g., the pseudo-quantum annealing execution unit 15) executes pseudo-quantum annealing using calculated multiple inverse temperatures.

According to such a configuration, the time to find an optimal solution to a combinatorial optimization problem can be reduced.

The first energy change calculation means 71 may calculate coefficient of each variable representing state of each spin as the first energy change by expanding the constraint term.

The second energy change calculation means 72 may also convert the objective function to form of predetermined model (e.g., the Ising model), and calculates at least one of statistical value of constants (e.g., J′ᵢⱼ) representing interaction between spins in the form of the predetermined model and a statistical value of each constant (e.g., h′ᵢ) corresponding each spin in the form of the predetermined model, as the second energy change.

It is also possible that annealing means 75 may repeats
a process of determining all spins as unselected,
a process of selecting one spin from unselected spins,
a process of determining whether or not to flip the one selected spin, and flipping the one selected spin when it is determined to flip the one selected spin, and
a process of changing the inverse temperature to an inverse temperature that is higher than current inverse temperature and closest to the current inverse temperature when determination was made to flip for at least one spin after determining whether or not to flip for all spins, and changing the inverse temperature to an inverse temperature that is lower than the current inverse temperature and closest to the current inverse temperature when determination was made not to flip all spins.

Although the present invention has been described above with reference to the example embodiment, the present invention is not limited to the above example embodiment. Various changes can be made to the configuration and details of the present invention that can be understood by those skilled in the art within the scope of the present invention.

### INDUSTRIAL APPLICABILITY

The present invention is suitably applied to the solution of combinatorial optimization problems.

### REFERENCE SIGNS LIST

1 Solution system
10 Input unit
11 First energy change calculation unit
12 Second energy change calculation unit
13 Third energy change calculation unit
14 Inverse temperature calculation unit
15 Pseudo-quantum annealing execution unit

What is claimed is:

1. A solution system comprising:
a memory configured to store instructions; and
a processor configured to execute the instructions to:
calculate, when given an expression that represents energy in a combinatorial optimization problem and that includes an objective function and a constraint term, first energy change which is change of value of the constraint term when flipping any spin in each local solution of the combinatorial optimization problem;
calculate second energy change which is change of a value of the objective function when flipping any spin in each local solution;
calculate multiple types of third energy changes which are changes of the energy represented by the expression when flipping any spin in each local solution, based on the first energy change and the second energy change;
calculate an inverse temperature at which any of spins can be flipped in each local solution for each individual third energy change, and calculate an inverse temperature at which the spins can be regarded as not being able to flip in each local solution; and
execute pseudo-quantum annealing using calculated multiple inverse temperatures.

2. The solution system according to claim 1,
wherein the processor calculates coefficient of each variable representing state of each spin as the first energy change by expanding the constraint term.

3. The solution system according to claim 1,
wherein the processor converts the objective function to form of predetermined model, and calculates at least one of statistical value of constants representing interaction between spins in the form of the predetermined model and a statistical value of each constant corresponding each spin in the form of the predetermined model, as the second energy change.

4. The solution system according to claim 1,
wherein the processor repeats
a process of determining all spins as unselected,
a process of selecting one spin from unselected spins,
a process of determining whether or not to flip the one selected spin, and flipping the one selected spin when it is determined to flip the one selected spin, and
a process of changing the inverse temperature to an inverse temperature that is higher than current inverse temperature and closest to the current inverse temperature when determination was made to flip for at least one spin after determining whether or not to flip for all spins, and changing the inverse temperature to an inverse temperature that is lower than the current inverse temperature and closest to the current inverse temperature when determination was made not to flip all spins.

5. A solution method, implemented by a computer, comprising:
calculating, when given an expression that represents energy in a combinatorial optimization problem and that includes an objective function and a constraint term, first energy change which is change of value of the constraint term when flipping any spin in each local solution of the combinatorial optimization problem;
calculating second energy change which is change of a value of the objective function when flipping any spin in each local solution;
calculating multiple types of third energy changes which are changes of the energy represented by the expression when flipping any spin in each local solution, based on the first energy change and the second energy change;
calculating an inverse temperature at which any of spins can be flipped in each local solution for each individual third energy change, and calculating an inverse temperature at which the spins can be regarded as not being able to flip in each local solution; and
executing pseudo-quantum annealing using calculated multiple inverse temperatures.

6. The solution method according to claim 5
wherein the computer calculates coefficient of each variable representing state of each spin as the first energy change by expanding the constraint term.

7. A non-transitory computer-readable recording medium in which a solution program is recorded, wherein the solution program causes a computer to execute:
a first energy change calculation process of calculating, when given an expression that represents energy in a combinatorial optimization problem and that includes an objective function and a constraint term, first energy change which is change of value of the constraint term when flipping any spin in each local solution of the combinatorial optimization problem;
a second energy change calculation process of calculating second energy change which is change of a value of the objective function when flipping any spin in each local solution;
a third energy change calculation process of calculating multiple types of third energy changes which are changes of the energy represented by the expression when flipping any spin in each local solution, based on the first energy change and the second energy change;
an inverse temperature calculation process of calculating an inverse temperature at which any of spins can be flipped in each local solution for each individual third energy change, and of calculating an inverse temperature at which the spins can be regarded as not being able to flip in each local solution; and
an annealing process of executing pseudo-quantum annealing using calculated multiple inverse temperatures.

8. The non-transitory computer-readable recording medium in which the solution program is recorded, according to claim 7
wherein the solution program causes the computer to execute,
calculating coefficient of each variable representing state of each spin as the first energy change by expanding the constraint term, in the first energy change calculation process.
